(19) United States
(12) Patent Application Publication
(10) Pub. No.: US 2006/0265272 A1
(43) Pub. Date: Nov. 23, 2006

(54) System and methods for re-evaluating historical service conditions after correcting or exempting causal events

(76) Inventors: Patrick A. Bosa, Exeter, NH (US); Matthew Hagen, Berwick, ME (US); Thomas S. Pantelis, Portsmouth, NH (US)

Correspondence Address: LAHIVE & COCKFIELD, 28 STATE STREET, BOSTON, MA, 02109, US

(21) Appl. No.: 11/131,540

(22) Filed: May 17, 2005

(51) Int. Cl. G06Q 99/00; G07G 1/00; G06F 17/30

(52) U.S. Cl. 705/10; 705/1

(57) ABSTRACT

A system and methods for determining an operational characteristic of a business process associated with a network. An operational characteristic of the business process is determined. An action is taken to modify a parameter associated with a change in the operational characteristic of the business process. The operational characteristic of the business process is re-determined.

### FIELD OF THE INVENTION

The present invention relates to a method and apparatus for determining operational characteristics of a business process associated with a network, and, in particular, for evaluating a state of a business process associated with a network.

### BACKGROUND OF THE INVENTION

A service level agreement (SLA) is often written in a manner stating an expected quality of service, amongst other details, that a service provider will provide to a customer. The service level agreement often guarantees a percentage of uptime during a particular period of use. Service level agreements typically specify types of events or causes of events that are considered exempt from the agreement and any service downtime or degradation caused by such an exempt event is not typically considered in evaluating and calculating the percentage of uptime.

A service provider may make certain guarantees in a service level agreement regarding the quality of the service the customer will receive. For example, the service provider may guarantee 99% availability of a selected service each month. In a 30-day period, the selected service could have no more than four hundred and thirty-two minutes of downtime to meet this guarantee. To manage this SLA, the service provider should know when the service is available and when it is not, and should also record the amount of downtime and provide a report at the end of the guarantee period showing the performance of the service.

One manner in which service providers may evaluate a service under agreement is to monitor the condition or status of elements in a network used to deliver services over the network, and infer the quality of the service being delivered. The service may be normal (or acceptable), down (or unacceptable), or compromised in some way.

Some service providers may apply rules to the condition or status of elements in the network to evaluate the service. There are many ways of encoding rules to infer the condition of the service based on the condition of network elements. In many methodologies, the condition of the service is inferred the moment a change occurs in the condition or status of a network element.

Often, a system monitoring the network elements can detect events that may compromise service delivery but cannot determine the cause of the event or determine whether the event should be exempt. In an attempt to solve this problem, conventional methods often require an administrator to interact with the system to indicate which events are exempt from the service level agreement. To be accurate, however, the system must recall the condition of all the monitored infrastructure elements contributing to the health of the service at the time of the exempted event, and re-evaluate the services condition for that period. It is incorrect to presume that, had the event not occurred, the service would have been acceptable or normal during the time period of the exempted event. However, this does not account for a partially coinciding event that occurred which compromised the service during a portion of the time period.

Additionally, for example, some service level agreements may require a service provider to accumulate downtime (or degraded time) per connection or per site that is unavailable, and accumulate the downtime for a whole network. If one network element is down because of an exempt event, but another network element is down because of a non-exempt event, some down time should still be recognized during that period.

A mechanism is desired for accurate reevaluation of the condition of a service at some point in history after an infrastructure event is exempted.

### SUMMARY OF THE INVENTION

The present invention relates to a system and methods for determining an operational characteristic of a business process associated with a network. This invention provides a mechanism for accurately reevaluating the condition of a service at some point in history after an event is exempted from a service level agreement (SLA). Furthermore, this invention accurately updates the evaluation of an amount of time of unacceptable service appropriately considering specific methods of time accumulation.

The present invention allows a user to specify a guarantee level and a warning level in an SLA model. When the service model or resource monitor model associated with a guarantee model is not up, the guarantee model accumulates time of unacceptable service (down time, degraded time, or time with a loss of redundancy), and will alert the user when either the warning level or violation level is reached. When the service model or resource monitor condition returns to a normal state (or uptime), the guarantee model stops accumulating time.

In one aspect of the present invention, a method is disclosed for monitoring a business process associated with a network. Performance of the method determines an operational characteristic of the business process. The method includes a step to modify a state of an event associated with a change in the operational characteristic of the business process. Once the state of the event is modified, performance of the invention includes a re-determining of the operational characteristic of the business process.

In one embodiment of the present invention, a cause is determined for the change in the operational characteristic of the business process. In another embodiment of the present invention, a state of an event associated with a business process element is monitored. In yet another embodiment of the present invention, a state of an event associated with the cause for the change in the operational characteristic of the business process is determined.

In another aspect of the present invention, a method is disclosed for analyzing an operational characteristic of a business process associated with a network. Data about a business process is received. An operational characteristic of the business process is analyzed. An input to modify a state of the event associated with the operational characteristic is received and the state of the event is modified. The operational characteristic of the business process is re-analyzed, responsive to the modified state of the event.

In one embodiment, data relating to the modification of the state of the event associated with the operational characteristic of the business process is stored. In another embodiment, a determination is made to send an alarm when a change in the operational characteristic of the monitored business process occurs.

In still another aspect, the invention relates to a system for monitoring a business process associated with a network. An evaluation mechanism is configured to determine an operational characteristic of the business process. An interface is configured to collect information about a state of an event associated with a change in the operational characteristic of the business process. A collection mechanism is configured to gather information about the change in the operational characteristic of the business process. An alarm mechanism is configured to take an action when a change in the operational characteristic of the business process occurs.

In one embodiment, the present invention consists of a modeling mechanism collecting data about at least one state of an event associated with the change in the operational characteristic of the business process. In another embodiment, the evaluation mechanism determines the change in the operational characteristic of the business process by evaluating received data. In other embodiments, the evaluation mechanism determines a cause for the change in the operational characteristic of the business process by evaluating the state of the event.

In yet another aspect, the invention relates to a system for determining an operational characteristic of a business process associated with a network. An interface collects system information from one or more resources. An evaluation server monitors a state of a business process associated with a network, identifies an operational characteristic of the business process based upon a state of an event associated with the business process, receives system information from the interface, and makes a determination as to the operational characteristic of the business process based upon the received system information.

In one aspect of the present invention, a computer readable medium holding computer readable instructions for performing a method for monitoring a business process associated with a network is disclosed. Performance of the method determines an operational characteristic of a business process, modifies a state of an event associated with a change in the operational characteristic of the business process, and automatically re-determines the operational characteristic of the business process. The operational characteristic can indicate an availability of a business process service.

The medium can also hold instructions to monitor a state of an event associated with a business process element.

In one embodiment, modifying a state of an event associated with a change in the operational characteristic of the business process includes the step of identifying the state of the event as exempt from a service level agreement. In another embodiment, modifying a state of an event associated with a change in the operational characteristic of the business process includes the step of identifying the state of the event as subject to a service level agreement.

In one embodiment of the present invention, the medium includes instructions for determining a cause for the change in the operational characteristic of the business process. In another embodiment of the present invention, the medium includes instructions for determining a state of an event associated with the cause for the change in the operational characteristic of the business process.

In another embodiment of the present invention, the medium can include instructions for collecting data associated with the cause for the change in the operational characteristic of the business process. In one embodiment of the present invention, determination of a change in an operational characteristic of the business process includes the step of evaluating the state of the event. In one embodiment, automatically re-determining the operational characteristic of the business process includes the step taking an action to disregard an event. In another embodiment, automatically re-determining the operational characteristic of the business process includes the step of applying a rule to the operational characteristic to determine whether to transmit an alert.

In one embodiment of the present invention, the medium includes instructions for modeling the business process.

### BRIEF DESCRIPTION OF THE DRAWINGS

These and other aspects of this invention will be readily apparent from the detailed description below and the appended drawings, which are meant to illustrate and not to limit the invention, and in which:

FIG. 1A is a block diagram illustrating one embodiment of a network environment suitable for practicing the illustrative embodiment of the present invention;

FIG. 1B is a block diagram illustrating network device 12 in greater detail;

FIG. 2 is a block diagram depicting an illustrative embodiment of the present invention;

FIG. 3 is a block diagram depicting in greater detail one embodiment of an SLA model in the present invention;

FIG. 4 is a block diagram depicting in further detail the attributes of a resource monitor;

FIG. 5 is a block diagram depicting in greater detail the attributes of a guarantee;

FIG. 6 is a flow diagram depicting one embodiment of the steps taken to determine an operational characteristic of a business process;

FIG. 7 is a flow diagram depicting one embodiment of the steps taken to modify a parameter associated with an operational characteristic of a business process as part of analyzing the operational characteristic;

FIG. 8 is a flow diagram depicting one embodiment of the steps taken to respond to a parameter value change;

FIG. 9 is a flow diagram depicting one embodiment of the steps taken to evaluate a policy;

FIG. 10 is a flow diagram depicting one embodiment of the steps taken to evaluate a rule;

FIG. 11 is a flow diagram depicting in greater detail one embodiment of the steps taken to add or remove a resource from consideration in determining the resources to include in identifying aggregate values;

FIG. 12 is a flow diagram depicting one embodiment of the steps taken to process an exemption;

FIG. 13 is a block diagram depicting an embodiment of a system for monitoring a business process associated with a network; and

FIG. 14 is a block diagram depicting an embodiment of a system for determining an operational characteristic of a business process associated with a network.

### DETAILED DESCRIPTION

The present invention relates to a system and methods for determining an operational characteristic of a business process associated with a network. This invention provides a mechanism for evaluating a condition or state of a service at some point in history based on a record of the state of its constituent parts, such as an application or a network element, and based on additional information or directives provided by an administrator or another data source. The additional information may be a correction to a record of events or a directive to not consider one or more events in determining an amount of degraded service because an event is exempt from a particular service level agreement.

Before continuing with the discussion below it is helpful to first define the use of a few terms.

The term “network device,” refers to an electronic device or apparatus configured for use in a network environment that is able to understand and perform operations with data according to a data communication protocol. Examples of a network device include, but are not limited to, a switch, a router, a server, a bridge, a workstation, a laptop, a desktop PC, a mainframe, a printer, a network appliance including a load balancer, a firewall, intrusion detection system (IDS) device, and the like.

The term “network resource,” refers to a resource on a network device. Examples of a network resource include, but are not limited to, computer memory, computer time, disk space, application software, database software, and the like. Additionally network resources may include parameters associated with software and hardware probes used for synthetic transactions or passive transaction monitoring to determine actual response times for services. A synthetic transaction may include a transaction executed by a software agent providing response time measurements to a management system.

The term “business process,” as used herein, refers to a process that relies in part on a set of network resources to perform one or more operations or functions in support of the business process. Such business processes can include, for example, business services and applications, such as order entry, accounts payable, product manufacturing, source control, customer relationship management, securities trading, facility security and surveillance, direct deposit, and transparent data services. A business process may include one or more business process elements or resources providing functionality or support for the business process.

The term “collection mechanism” or “monitoring mechanism” refers to a hardware or software component that collects network related information for the purpose of monitoring network activity.

The term “management station,” refers to an electronic device configured to execute an application for interacting with a collection mechanism. Common management station functions include network topology mapping, event trapping with alarms, traffic monitoring, network diagnostic functions, report generators, historical record management, and trend analysis.

The term “event” refers to an infrastructure change.

The term “unacceptable service” refers to any of several categories of unacceptable service. These categories include, without limitation, down time, degraded time, and time with lost redundancy or resiliency. The type of service deemed unacceptable may vary per service level agreement.

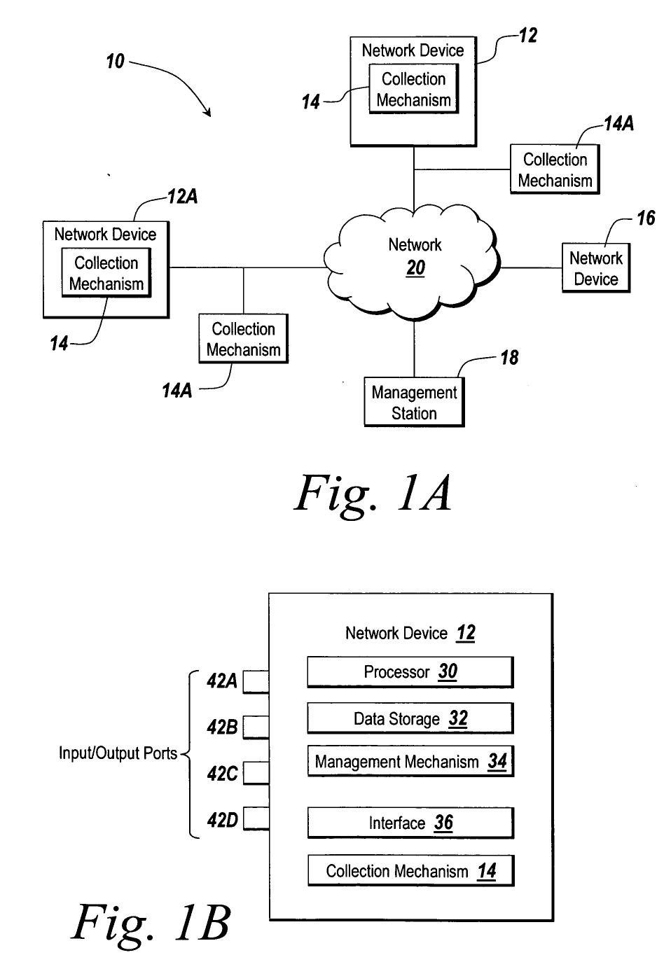

FIG. 1A illustrates one embodiment of a network environment suitable for practicing the illustrative embodiment of the present invention. Network environment 10 includes network devices 12 and 12A, network device 16, management station 18, and network 20. Network devices 12 and 12A, network device 16, and management station 18 are capable of communicating with each other across network 20 using one or more communication protocols and are further capable of communicating with one or more network devices associated with another network (not shown). Network 20 can be the Internet, an intranet, a LAN, a WAN, or other suitable network either wired, wireless or a hybrid of wired and wireless.

Network devices 12 and 12A each include collection mechanism 14. Collection mechanism 14 is capable of collecting values of one or more parameters indicating an operational characteristic of the network device associated with the collection mechanism. Alternatively, collection mechanism 14A is capable of collecting values of one or more parameters indicating an operational characteristic of a portion or segment of network 20, network device 16, or both. Collection mechanisms 14 and 14A, in response to a request, are further capable of transmitting statistical information concerning the associated network device or associated segment of network 20 to management station 18. Collection mechanisms 14 and 14A can be an RMON probe or an RMON agent. As such, management station 18 is configurable as an RMON compatible network management station able to communicate with network devices 12 and 12A, and network device 16 using SNMP commands. Collection mechanisms 14 and 14A can be an SNMP agent or an SNMP probe. Collection mechanisms 14 and 14A can be a CMIP agent or a CMIP probe. Collection mechanisms 14 and 14A can be a proprietary agent or a proprietary probe. Collection mechanisms 14 and 14A can be an element management system or network management system or application management system.

Management station 18 communicates with collection mechanisms 14 and 14A using the IP suite of protocols. Management station 18 can configure and instruct collection mechanisms 14 and 14A, either collectively or individually, as to what data collect and what statistics to maintain about network devices 12, 12A, network device 16, and network 20. As will be discussed below in more detail, network device 12 and network device 12A provide an interface for a requestor such as, management station 18 or a user of management station 18 to communicate with collection mechanism 14 or 14A.

FIG. 1B illustrates network device 12 in more detail. Those skilled in the art will recognize the features discussed in relation to network device 12 are equally applicable to network device 12A. Network device 12 includes processor 30, data storage device 32, management mechanism 34, interface 36, collection mechanism 14, and input/output ports 42A-42D. Those skilled in the art will appreciate that the input/output ports network device 12 are configurable as discrete input ports for receiving network traffic and discrete output ports for outputting network traffic so as to couple to a transmission medium having a single primary conductor for carrying network traffic in one direction. Moreover, those skilled in the art will recognize the input/output ports 42A-42D each couple to a transmission medium having at least two primary conductors, with at least one primary conductor carrying network traffic in a first direction and at least one primary conductor carrying network traffic in a second direction.

Microprocessor 30 is configured to execute various instructions and programs, and control various hardware and software components such as network interface cards and various software components and mechanisms such as, but not limited to agents and probes. Data storage device 32 provides storage for one or more executable programs, such as one or more OS programs and various other program applications developed in a variety of programming environments for controlling device software and hardware components. Data storage device 32 can further hold data collected by collection mechanism 14, for example a log.

Management mechanism 34 is configured to receive a query request from a requestor for configuring collection mechanism 14 to collect and if desired evaluate a value of a selected parameter that represents an operational characteristic of the network device. Collection mechanism 14 is configurable in response to the query request to search a MIB structure at expiration of a sampling period, locate in the MIB structure each MIB object instance or instances identified by the query request, and for each located MIB object instance evaluate the value of a variable or parameter of each instance of the MIB object identified by the query request. Those skilled in the art will recognize that evaluation of the value by the collection mechanism 14 or 14A can include the comparison of the value to an upper threshold value or to a lower threshold value or to both, to determine an absolute change in the value or a determine a delta change in the value.

Once configured, collection mechanisms 14 and 14A can monitor a value of a variable or parameter associated with all or selected MIB objects. As such, collection mechanisms 14 and 14A are capable of warning the network administrator if a parameter of a monitored MIB object rises above a predefined threshold, falls below a predefined threshold or falls outside a predefined range. Collection mechanisms 14 and 14A are able to monitor a specific variable of a specific MIB object instance and trigger an RMON like alarm when the value crosses an upper threshold or crosses a lower threshold.

Interface 36 in conjunction with management mechanism 34 provides a user of network device 12 or management station 18 with an interface to construct a query expression to evaluate a variable or parameter indicating an operational characteristic of the network 20 or network device 12.

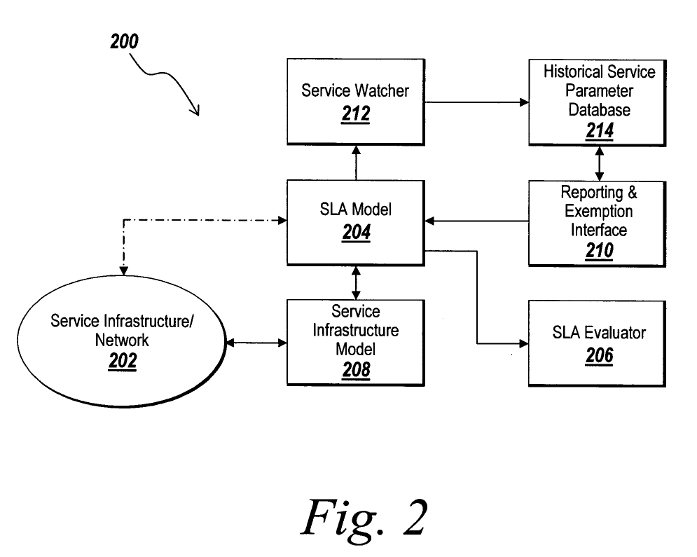

Referring now to FIG. 2, a block diagram depicts an illustrative embodiment of the present invention in a system 200, including a service infrastructure/network 202, a service level agreement (SLA) model 204, an SLA evaluator 206, a service infrastructure model 208, a reporting and exemption interface 210, a service watcher 212, and a historical service parameter database 214.

The SLA model 204 models the business processes provided by a service provider and the guarantees that the service provider makes to customers. A service infrastructure model 208 models a service infrastructure/network 202. The service infrastructure model 208 monitors or polls parameters of the components in the service infrastructure/network 202. In some embodiments, monitoring comprises listening for traps or other asynchronous messages that indicate a parameter change in the infrastructure. In some embodiments, the components are network elements. In other embodiments, the components are elements associated with a business process.

In some embodiments, the modeling of the business process may be limited to identifying which parameters are indicators of the service health. In some of these embodiments, a complete model of the underlying business process may not be necessary. In some embodiments, service monitoring comprises a “round trip test” to be performed periodically from first network device to a second network device. In these embodiments, if the result of the test exceeds a threshold (for example, the level at which the service would degrade or the level at which the service provider has issued a guarantee), the test indicates that the service health is degraded. If the test “times out” (i.e. receives no response from the server), the test indicates that the service health is in unacceptable condition.

In one embodiment, parameters associated with a business process are used as indicators of service health. In other embodiments, the present invention is preconfigured to identify for each service the types and contexts of events that indicate service disruption or degradation and the types and contexts of events that indicate service restoration. In these embodiments, multiple overlapping service outage events may be recorded and the service health may be re-evaluated for that period given other coinciding events.

The service infrastructure model 208 communicates a change in a monitored parameter of a business process element to the SLA model 204. The SLA model 204 registers with the service infrastructure model 208 to receive information from the service infrastructure model 208. In some instances, the service infrastructure model 208 transmits a notification of a change in a parameter to the SLA model 204. The SLA model 204 can receive the notification in an electronic message from the service infrastructure model 208. In another embodiment, the SLA model 204 receives the notification in a spreadsheet from the service infrastructure model 208.

In other embodiments, the SLA model 204 identifies a change in a parameter by directly monitoring a business process element in the service infrastructure/network 202. In some of these embodiments, for example, the SLA model 204 communicates directly with a business process element to monitor a parameter. In others of these embodiments, for example, the SLA model 204 receives the contents of a parameter from a software agent.

In still other embodiments, the SLA model 204 receives a notification about the parameter changes from another business process element. In some of these embodiments, the SLA model 204 registers with a network management system (NMS) that maintains the service infrastructure model 208. In this embodiment, the NMS notifies the SLA model 204 when a monitored parameter changes. In some of these embodiments, the SLA model 204 receives a notification of parameter changes from the NMS. In one embodiment, the SLA model 204 receives the notification in an electronic message from the NMS. In another embodiment, the SLA model 204 receives the notification in a spreadsheet from the NMS.

Upon notification to the SLA model 204 of a parameter change, the SLA model 204 informs the service watcher 212 of the parameter change. In one embodiment, the SLA model 204 transmits the notification to the service watcher 212. In another embodiment, the SLA model 204 transmits an identification of the changed parameter to the service watcher 212. In still another embodiment, SLA model 204 transmits information about the changed parameter to the service watcher 212.

The service watcher 212 responds to the notification of a parameter change from the SLA model 204 by recording information about the business process at the time of the parameter change. This information may include, without limitation, the service condition, root cause, time of change, related parameters, and resource data. In some embodiments, the service watcher 212 can store this information in the historical service parameter database 214.

In some instances, the SLA model 204 also transmits a notification of a parameter change to the SLA evaluator 206. In one embodiment, the SLA model 204 transmits the notification to the SLA evaluator 206. In another embodiment, the SLA model 204 transmits an identification of the changed parameter to the SLA evaluator 206. In still another embodiment, SLA model 204 transmits information about the changed parameter to the SLA evaluator 206. In some of these embodiments, the SLA model 204 requests that the SLA evaluator 206 make an initial determination of the condition of a service associated with the changed parameter.

A user interacts with a user interface, such as the reporting and exemption interface 210, to obtain a report of events that caused unacceptable service. The unacceptable service is indicated by the initial determination of the SLA evaluator 206 upon the request of the SLA model 204. In some embodiments, the user may mark an event exempt by using an independent application to issue an instruction to exempt an event. The user may select the event to exempt from a list presented to the user via the user interface. The user may exempt the event using a graphical user interface element, such as a checkmark box. The user may mark one or more events exempt. In one embodiment, when a user marks an event as exempt, the reporting and exemption interface 210 retrieves all data related to the service at the time of the exempted event from the historical service parameter database 214, and passes this and an identifier of the exempted event to the SLA model 204 for re-evaluation.

In some embodiments, an event comprises a period of time in which the condition or state of a service was unacceptable. In other embodiments, an event comprises a value of a parameter of a business process element over a period of time during which the business process element contributed to the service condition being in an unacceptable state. In one embodiment, a state of an event indicates that the event is subject to a service level agreement. In another embodiment, the state of the event indicates that the event is exempt from a service level agreement. In some embodiments, a parameter associated with a business process comprises a state of an event.

In one embodiment, in addition to receiving input from a user regarding an exempt event, the reporting and exemption interface 210 may produce a report indicating performance of a service relative to the guarantees specified by the SLA. In addition to a summary, such as total amount of unacceptable service per month, the reporting and exemption interface 210 can provide details including, but not limited to, which business process element or elements were responsible for each period of unacceptable service. A user receiving the report may, in some embodiments, filter and search for particular resources or particular periods. In some embodiments, this report forms a portion of the interface presented to a user prior to the user marking an event as exempt from an SLA.

Upon notification of a user marking an event as SLA exempt, the SLA model 204 then transmits a re-evaluation request to the SLA evaluator 206 to re-evaluate the service condition. In turn, the SLA evaluator 206 calculates the amount of unacceptable time accumulated and adjusts accumulated unacceptable time, responsive to the user input and information received from the SLA model 204. This information includes information about the exempted event. The SLA evaluator 206 sends information including, but not limited to, the re-evaluated condition, root-cause information, and related parameters to the reporting and exemption interface 210. In one embodiment, the SLA evaluator 206 transmits this information to the reporting and exemption interface 210 via the SLA model 204. In one embodiment, the reporting and exemption interface 210 stores the data received from the SLA model 204 in a separate exemption table.

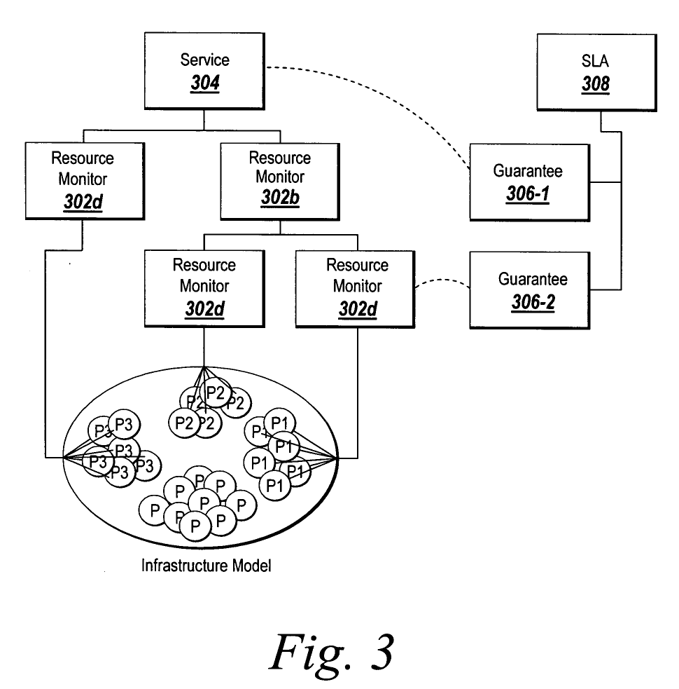

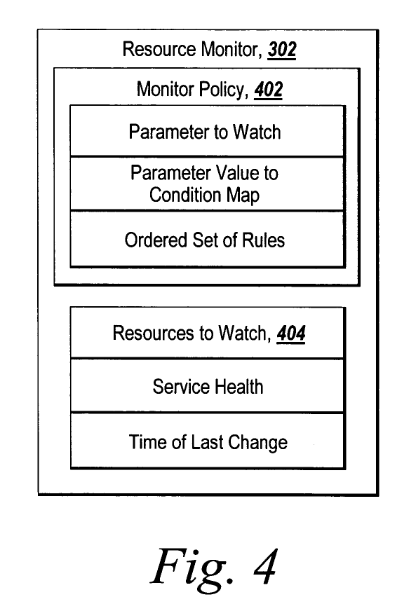

FIG. 3 is a block diagram depicting in greater detail one embodiment of an SLA model 204, including a resource monitor 302, a service model 304, a guarantee 306, and a service level agreement 308. The SLA model 204 may include a mechanism for evaluating one or more parameters on a set of business process elements or resources to determine the health of a service or a portion of the service. In one embodiment, the SLA model 204 therefore comprises at least one resource monitor 302, with each resource monitor 302 monitoring a parameter P of a set of resources by either polling or registering for value change notification with a network management system or element management systems.

In FIG. 3, each resource monitor 302 monitors a state or a value of a single parameter of different infrastructure elements. FIG. 3 depicts, for example, resource monitor 302a monitoring the parameter P3 on multiple business process elements within the service infrastructure model 208. There may be multiple resource monitors 302a . . . 302x to provide sufficient monitoring for the parameters P in a set of business process elements or resources. Similarly, multiple guarantees 306 may be required for monitoring of a particular business process.

To infer the condition of a service, in some embodiments, many different parameters across a set of managed business process elements require monitoring. To accomplish this with the present invention, a service model 304 would be associated with multiple resource monitors 302. In this embodiment, the service model 304 monitors the portion of the associated resource monitors 302 related to the service. The service is, in some embodiments, the service subject to the service level agreement. A business process element providing the service may have a plurality of resource monitors 302 associated with it.

The guarantees 306 further monitor one or more resource monitors 302 and apply an SLA 308 to the monitored resource monitors 302. The guarantees 306 may comprise methods for accumulating amounts of time of unacceptable service. In these embodiments, the guarantees 306 apply the accumulation methods to the information contained in the monitored resource monitors 302 and, through this process, the guarantees 306 determine for a particular service the amount of unacceptable service experienced. In some embodiments, the guarantees 306 transmit an alarm about the condition of a monitored service. In some of these embodiments, the guarantees 306 transmit the alarm to a user of the reporting and exemption interface 210. In others of these embodiments, the guarantees 306 transmit the alarm to an administrator of a business process.

FIG. 4 depicts in further detail the attributes of the resource monitor 302. The resource monitor 302 includes a monitor policy 402 and a set of resources 404. In some embodiments, the resource monitor 302 includes a monitor policy 402. The monitor policy 402 comprises, without limitation, the identification of the type of monitored parameter (i.e., port status, availability, transaction latency, memory utilization, error rate, etc.). In other embodiments, the resource monitor 302 includes a mapping of parameter values to discrete conditions such as up, down, degraded, loss of redundancy. In still other embodiments, the resource monitor 302 includes an ordered set of rules that determines the resource monitor condition based on the monitored parameter values. The monitored parameter may be of any data type (including integer, real, text, Object ID, etc.) but, in most embodiments, there exists a mapping from parameter values to the discrete condition values.

Those skilled in the art will appreciate that for parameters without discrete values, a parameter-value mapping may not exist. For example, a statistic parameter with continuous real values, such as percentage of error rate, instead of performing or creating a parameter value map, a rule set composed of aggregate rules can be used or referred to. Aggregate rules are well suited for use with parameters that don't have discrete condition values. One example of an aggregate rule can be when maximum error rate is greater than twenty, service is degraded.

In one embodiment, a monitor policy 402 may be stateless, given a set of parameters to evaluate. In another embodiment, the monitor policy 402 may be stateful, maintaining the parameter set or the portion of the parameter set necessary to evaluate itself.

Each resource monitor 302 has a set of resources 404 to monitor. In some embodiments, the resource monitor 302 comprises a data structure reflecting the result of the monitor policy evaluation of the watched parameters. In one of these embodiments, the data structure includes an indication of system health. In another embodiment, the data structure includes an indicator of the current system time. In one embodiment, when the policy is evaluated and the condition is changed, or a set of parameters causes the state of any rule in the policy to change, the data structure updates the current system time to indicate the time of the last change. The guarantees 306 and the service watcher 212 respond to updates of this attribute of the data structure.

In one embodiment, to measure the performance of a service (or service component, i.e. resource monitor) that has an associated guarantee 306, resource data is logged when the service 304 changes condition. In one embodiment, this data is saved in the historical service parameter database 214. In one embodiment, the historical service parameter database 214 is a relational database.

In one embodiment, the data structure within service 304 and resource monitors 302 include a trigger for indicating a change. The service watcher 210 watches for changes in this trigger for all services 304 and resource monitors 302 associated with guarantees 306. When a change is detected, the service watcher 210 requests, from the SLA model 204, a root cause of the current service condition. In one embodiment, the SLA model 204 responds with a structure containing sufficient data to reconstruct the monitor policy and current state of each rule, for the resource monitor 302 and also for all resource monitor children 302 of this resource monitor 302. The structure of one embodiment comprises a Root Cause Information section, including:
time stamp
current condition (which may be down, degraded, etc.)
monitor ID (to identify the service, sub-service, or resource monitor),
rule context list, which lists, in order of priority, for all rules that evaluated to TRUE:
   the rule name (ALL, ANY, %, Aggregate)
   the rule parameters (down, 10%, sum >30, etc.)
   the trigger cause list (which includes resource ID, parameter value, exempt flag, and notes for all resources in the cause list).

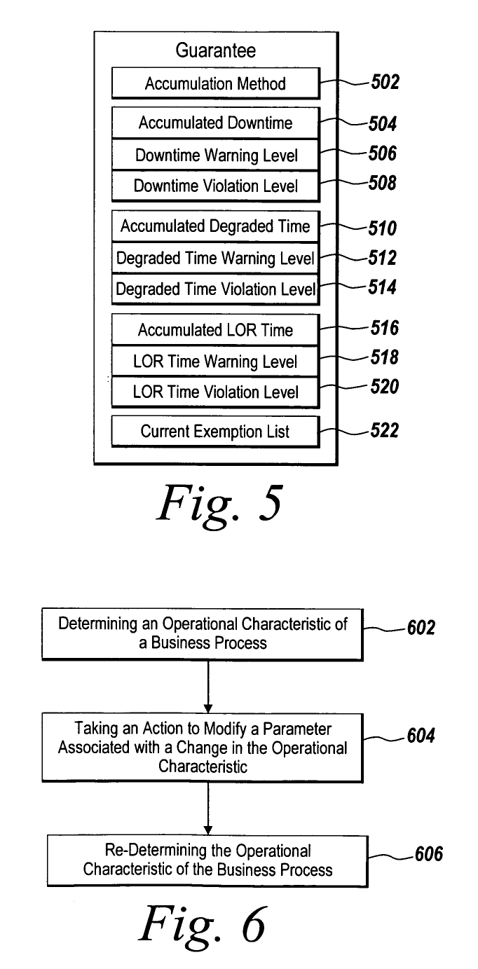

The monitor ID and time stamp identify the outage. The rule context list is used in re-evaluating the service condition a past point in time as described below, in FIG. 5.

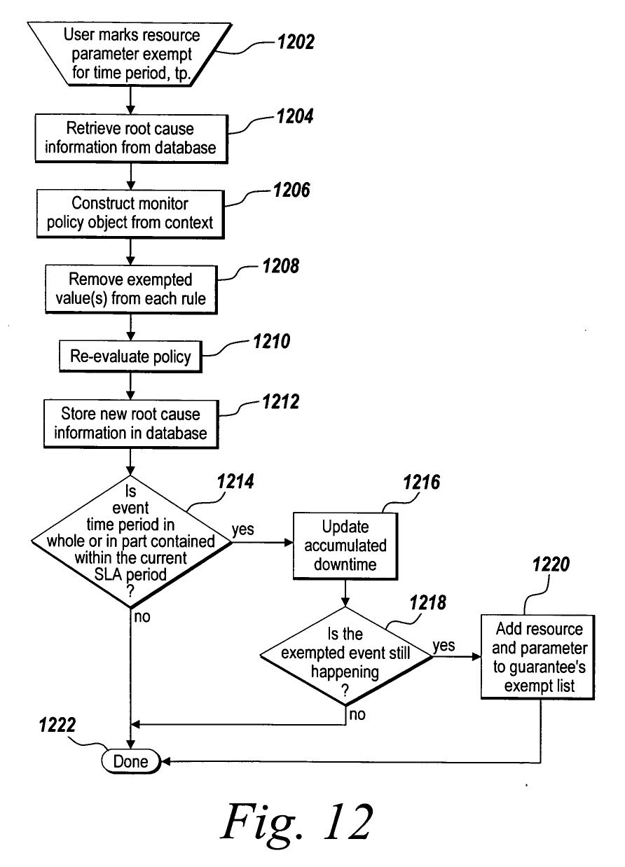

Referring ahead to FIG. 12, a flow diagram depicts one embodiment of the steps taken to process an exemption. A user marks a parameter associated with a resource exempt for a particular time period (step 1202). The reporting and exemption interface 210 will retrieve data about a root cause from a database (step 1204). The reporting and exemption interface 210 constructs a monitor policy object from the context (step 1206). The reporting and exemption interface 210 removes the exempted value from each rule (step 1208). The policy is re-evaluated after the removal of the exempted value (step 1210). Data forming a replacement root cause is stored in the database (step 1212).

The reporting and exemption interface 210 determines whether the event time period for which the parameter associated with the resource was exempted is in whole or in part contained with in the current SLA period (step 1214). If so, the reporting and exemption interface 210 updates the accumulated time of unavailable service (step 1216) and determines whether the exempted event continues in the current time (step 1218). If so, the reporting and exemption interface 210 adds the resource and the parameter to the guarantee's exempt list (step 1220). If not, or if the event is not contained in whole or in part within the SLA period (step 1222), the reporting and exemption interface 210 has completed processing the exemption.

Referring back now to FIG. 5, a block diagram depicts in greater detail the attributes of a guarantee 306 in one embodiment of an SLA model 204. A guarantee 306 may be associated with a whole service or with one or more resource monitors 302 of a service. The guarantee 306 has an accumulation method 502 that defines how various categories of unacceptable time (down time, degraded time, and time with lost redundancy) are each accumulated. The guarantee 306 accumulates the actual time of unacceptable service as the associated service 304 or resource monitor 302 reports it and stores it as accumulated downtime 504 or accumulated degraded time 510 or accumulated LOR time 516 for a time with loss of redundancy. The guarantee 306 compares the accumulated time of unacceptable service with a level of violation or warning. The accumulated downtime 504 is compared with the downtime warning level 506 and the downtime violation level 508. The accumulated degraded time 510 is compared with the degraded time warning level 512 or the degraded time violation level 514. The accumulated LOR time 516 is compared with the LOR time warning level 518 or the LOR time violation level 520. The guarantee 306 sends an alarm to a user if an accumulator exceeds a threshold indicated by a warning level or a violation level. The alarm may take the form of an alarm on an alarm console, or, in other embodiments, of an e-mail.

The guarantee 306 resets accumulated values to zero when a new guarantee period starts. The guarantee 306 maintains a list of the current events whose resource parameter values marked exempt in the current exemption list 522. The guarantee 306 prunes this list when the parameter value returns to a normal state.

In one embodiment of the present invention, a parameter on a resource being monitored changes to indicate a service outage. This outage is referred to as a service affecting event. If this service affecting event is marked as exempt prior to the parameter changing back to a value representing acceptable service, the service affecting event is added to a list of events currently marked exempt, labeled, in some embodiments, “Current Exemption List.” A resource monitor 302 ignores this resource parameter until it returns to a good/normal value. In some embodiments, a rule may indicate that when any two network devices or network resources are unreachable, a service is down and when any one router is unreachable the service is merely degraded. If one network device or network resource becomes unreachable because a customer site lost power, in one embodiment, a user may mark that event as exempt. If the second network device or network resource becomes unreachable (due to a provider failure) before power is restored to the first network device or network resource, the resource monitor 302 will again evaluate the service condition. Because the first network device or network resource is in the Current Exemption List, that network device or network resource will not be considered in the evaluation of the rule. The service is actually down, but the SLA will only record degraded time (if there is such a guarantee being made for this service). When the power is restored to first network device or network resource, the “contact status” parameter of that resource will change to a good value (established), and that resource is removed from the Current Exemption List. If that network device or network resource is lost again, the resource monitor 302 will consider it in the service health calculation.

When notified of a parameter change, the SLA model 204 also transmits the notification to the SLA evaluator 206 and requests that the SLA evaluator 206 make an initial determination of the condition of a service associated with the changed parameter. In response to a request to exempt a parameter for a period of time, the report and exemption interface 210 retrieves, from the historical service parameter database 214, the root cause structure for the associated resource monitor for the time period of the exempted event. A monitor policy object is constructed with this data. The parameter being exempted is then removed from the policy, and the policy is re-evaluated. The result of the new evaluation is then stored in the historical service parameter database 214, but in a separate table or other suitable data structure. The re-evaluation may show that the service would still have been unacceptable even if the exempted event had not occurred. Or, the re-evaluation may show that the category of the unacceptable service would have changed (i.e., degraded time instead of down time). Another possibility is that the service would still have been unacceptable, but the number of resources causing the condition has decreased. This is significant if the associated guarantee is accumulating unacceptable time by evaluating the number of unavailable resources.

Since the post-exemption data is stored in a separate table, it is possible to create a report showing either actual or corrected data. Also, a user can un-exempt an event. In such embodiments, the post-exemption data may be removed from this table.

Referring now to FIG. 6, a flow diagram depicts one embodiment of the steps taken in determining an operational characteristic of a business process associated with a network. In brief overview, a determination of an operational characteristic of a business process is made (step 602). An action is taken to modify a state of an event associated with a change in the operational characteristic of the business process (step 604). Finally, there is a re-determining of the operational characteristic of the business process (step 606) after modification of the state of the event.

In some embodiments, the business process is modeled. In other embodiments, no modeling occurs. In one embodiment, the step of monitoring a state of an event associated with a business process element accompanies the step of making an initial determination of an operational characteristic of a portion of a business process. In one embodiment, the SLA model 204 monitors a parameter and the SLA evaluator 206 makes the initial determination of an operational characteristic of the business process. In this embodiment, determining the operational characteristic may be responsive to the result of monitoring the parameter. In some embodiments, a parameter may be associated with more than one business process element or resource. In these embodiments, a resource monitor 302 is monitoring a parameter P for each of multiple business process elements or resources.

In some embodiments, the step of modifying a state of an event associated with a change in the operational characteristic of the business process is accompanied by the step of determining a cause for the change. In one of these embodiments, the user modifies the event by marking it as exempt through an interaction with the reporting and exemption interface 210. In some of these embodiments, a state of an event associated with the cause for the change in the operational characteristic of the business process is determined when a cause for the change in the operational characteristic of the business process is determined.

In some embodiments, data associated with the cause for the change in the operational characteristic of the business process is collected. The data associated with the cause for the change may be stored. In one of these embodiments, the data is stored in the historical service parameter database 214.

In others of these embodiments, other parameters associated with the change may be identified. In one of these embodiments, the parameters are identified by querying the historical service parameter database 214. The parameters or events associated with these parameters may also be modified. In one embodiment, the step of modifying a state of an event associated with a change in the operational characteristic of the business process is preceded by the state of the event being determined to be associated with the cause for the change in the operational characteristic of the business process.

In some embodiments, taking an action to modify a state of an event associated with a change in the operational characteristic of the business process includes the step of evaluating a state of an event. In one embodiment, the step of modifying a state of an event associated with a change in the operational characteristic of the business process includes marking the state of the event as exempt from a service level agreement. In another embodiment, the step of modifying a state of an event associated with a change in the operational characteristic of the business process includes marking the state of the event as subject to a service level agreement.

In one embodiment, the step of re-determining the operational characteristic of the business process occurs automatically. In another embodiment, the step of re-determining the operational characteristic of the business process occurs upon the request of a user for re-determination. In some embodiments, the step of re-determining the operational characteristic of the business process further comprises taking an action to disregard an event. In one of these embodiments, the event is disregarded because the state of the event indicated that the event was exempt from a service level agreement.

In one embodiment, the operational characteristic indicates availability of a business process or of a service associated with a business process. In some embodiments, the operational characteristic indicates that the business process is providing an acceptable level of service. In other embodiments, the operational characteristic indicates that the business process is providing an unacceptable level of service. Unacceptable service may indicate that the service is unavailable. Unacceptable service indicates, in other embodiments, that the quality of the service is degraded.

In some embodiments, an action is taken to transmit an alarm about the operational characteristic of the business process. In one of these embodiments, the guarantees 306 take this action. In some of these embodiments, the action is taken after applying a rule to the operational characteristic to determine whether to transmit an alarm. In one of these embodiments, the guarantees 306 include the rule or rules to apply and make the determination responsive to observing a change in an associated resource monitor 302.

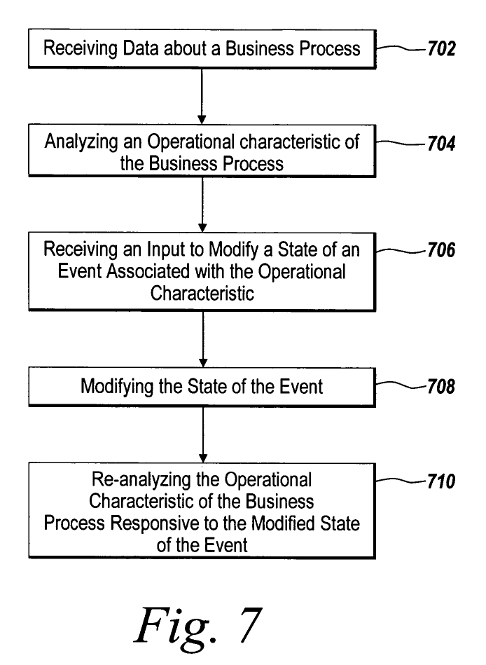

Referring now to FIG. 7, a flow diagram depicts one embodiment of the steps taken in modifying a state of an event associated with an operational characteristic of a business process as part of analyzing the operational characteristic. In brief overview, data about a business process is received (step 702). An operational characteristic of the business process is analyzed (step 704). Input is received to modify a state of the event associated with the operational characteristic (step 706) and the state of the event is modified (step 708). The operational characteristic of the business process is re-analyzed, responsive to the modified parameter (step 710).

Referring to FIG. 7, and in more detail, when data about a business process associated with a network is received (step 702), an operational characteristic of the business process is analyzed (step 704). In some embodiments, the network is modeled. In one embodiment, the SLA evaluator 206 performs analysis after receiving data from the SLA model 204. Input is received to modify a state of the event associated with the operational characteristic (step 706) and the state of the event is modified (step 708). In some embodiments, the input is received from a user. In other embodiments, the input is received from the reporting and exemption interface 210. In still other embodiments, the input indicates that the state of the event indicates an exemption from a service level agreement. In yet other embodiments, the input indicates that the state of the event indicates that the event is subject to a service level agreement.

In some embodiments, data relating to the modification of the state of the event associated with the operational characteristic of the business process is stored. In one embodiment, this data is stored in the historical service parameter database 214.

The operational characteristic of the business process is re-analyzed, responsive to the modified state of the event (step 710). In some embodiments, the re-analysis occurs automatically. Upon re-evaluation, an operation characteristic may change due to a particular state of an event. An operational characteristic may indicate that a business process is providing unacceptable service. A state of an event indicating an exemption may, in some embodiments, change an evaluation of an operational characteristic to indicate that the business process is providing acceptable service. In some embodiments, when the operational characteristic changes upon re-analysis, an alarm is sent when a change in the operational characteristic of the monitored business process occurs. In one embodiment, the guarantees 306 sends the alarm responsive to a change in a resource monitor 302. In some of these embodiments, determining to send an alarm further comprises applying a rule to determine to send the alarm. In one of these embodiments, the rule may indicate that an alarm should be sent when all parameters have a pre-defined state. In another of these embodiments, the rule may indicate that an alarm should be sent when a percentage of the parameters have a pre-defined state. In still others of these embodiments, the rule may indicate that an alarm should be sent when the aggregate of the parameters have a pre-defined state.

For example, in one embodiment of the present invention, four rule primitives are defined, from which actual rule instances or objects are created. Each primitive has certain parameters that must be defined when constructing an actual rule instance. The primitives are:

1. The All Rule. When all parameter values are <condition> report

<condition>

2. The Any Rule. When any <number> parameter value(s) is/are <condition> report <condition>

3. The Percent Rule. When <number>% of the parameter values are <condition> report <condition>

4. The Aggregate Rule. When the [Sum/min/max/ave] of the parameter values is [<,>,=] report <condition>

If a service is delivered at acceptable levels when either of two resources are up, a rule set like the following could correctly infer the condition of the service (if a parameter of both resources is monitored):
1. When all are DOWN, report DOWN.
2. When any 1 is DOWN, report L.O.R.
   If it was also the case that when both resources are degraded, the service is degraded, this rule may apply:
1. When all are DEGRADED report DEGRADED
   If a service is degraded or down with the collision rate or error rate of a port exceeds certain values, an aggregate rule can be used:
1. When the MINIMUM of the parameter values is GREATER THAN 50, report DOWN.
2. When the MINIMUM of the parameter values is GREATER THAN 30, report DEGRADED.
   When combined with the mapping from parameter values to discrete condition, discussed above in reference to FIG. 4, this set of rule primitives give the policy creator considerable flexibility and power to create rule sets that accurately determine the state of the service being managed.

To avoid the expense and intensive space requirements necessary to save every watched parameter of a resource monitor it is possible to store the context of a rule. The context includes the set of resources and parameter values contributing to the rule being triggered. For example, only one rule can provide the condition of the resource monitor at any one time, but when the root cause information structure is returned from the resource monitor, the rule context list has the context of every rule that was satisfied at the time, not just the satisfied rule with the highest precedence.

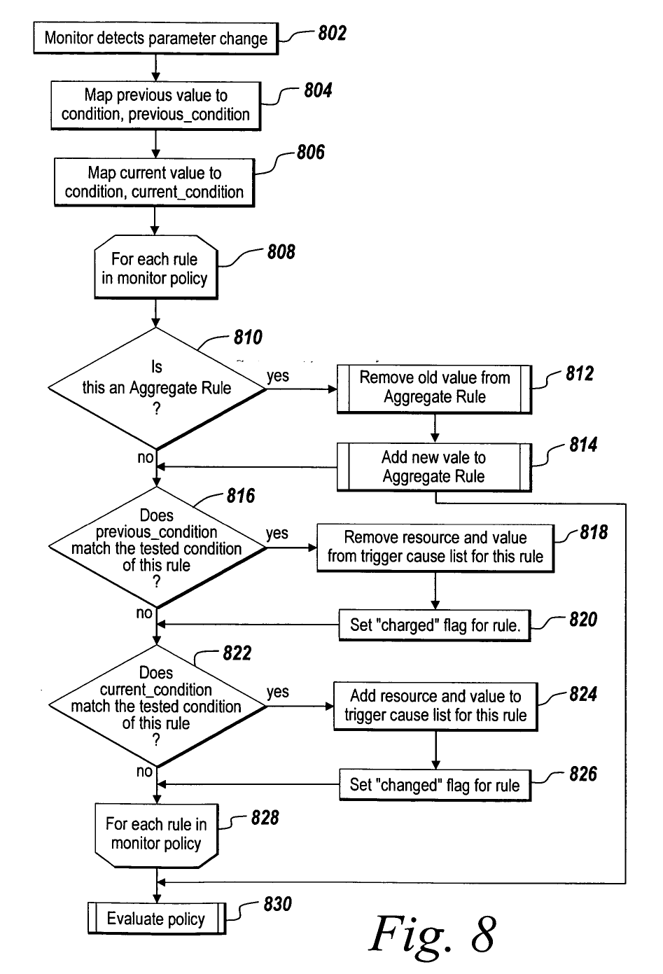

Referring now to FIG. 8, a flow diagram depicts one embodiment of the steps taken to respond to a parameter value change. A resource monitor 302 detects a parameter change (step 802) and maps the previous value to a variable for storing the previous condition (step 804). The resource monitor 302 maps the current value of the parameter to a variable for storing the current condition (step 806). The resource monitor 302 then examines each rule in the monitor policy (step 808). The resource monitor 302 determines whether the rule examined comprises an aggregate rule as described in FIG. 7 (step 810). If it does, the resource monitor 302 removes the previous value from a variable for storing a determination of time that has been aggregated under this rule (step 812).

For evaluating an aggregate rule, a parameter change is equivalent to removing the old parameter value and adding in the new parameter value. Because methods for adding and removing parameters may be defined to accommodate network and SLA model changes, one embodiment of this invention will invoke the methods described for removing a parameter and for adding a parameter to accomplish the evaluation of a parameter change. In another embodiment, a separate evaluation mechanism for processing parameter changes is defined.

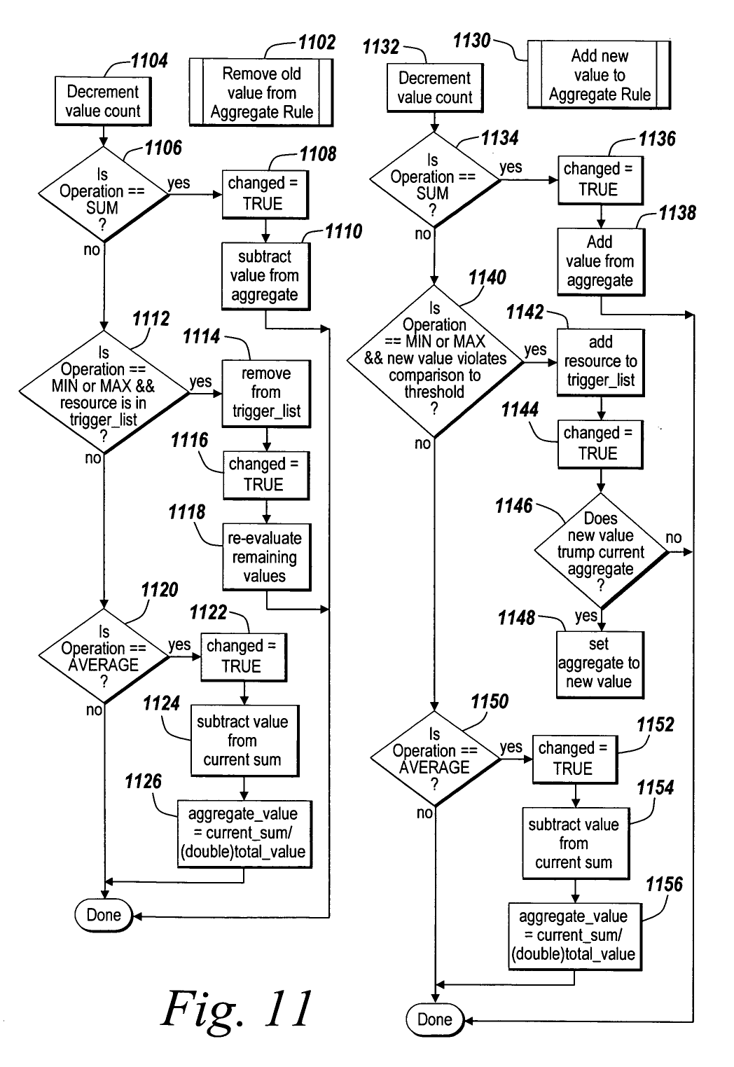

One example of removing the previous value from the variable when time has aggregated under this rule is substantially similar to the step of determining to remove a value from the existing aggregate value as described below in step 1102 of FIG. 11. Those skilled in the art will appreciate that other options are encompassed by the present invention. The resource monitor 302 then adds the new value to the variable (step 814) and proceeds to evaluate the policy responsive to the new value in the variable (step 830). One example of adding the new value to the variable and evaluating the policy responsive to the new value is substantially similar to the step of determining to add a value to the existing aggregate value as described below in step 1130 of FIG. 11. Those skilled in the art will appreciate that other options are encompassed by the present invention.

If the resource monitor 302 determines that the rule examined does not comprise an aggregate rule, the resource monitor 302 determines whether the variable storing the previous condition matches a tested condition of the rule (step 816). If the variable matches the condition tested by the rule, the resource monitor 302 removes the resource and the value from a trigger cause list associated with the rule (step 818). The resource monitor 302 stores the trigger cause list. The resource monitor 302 changes a flag or other indicator associated with the rule to indicate that the resource monitor 302 has changed values of variables associated with the rule (step 820).

After determining whether the previous condition of the parameter matched a tested condition of the rule the resource monitor 302 is examining, the resource monitor 302 determines whether the current condition of the parameter matches a tested condition of the rule (step 822). If the resource monitor 302 determines the current condition of the parameter does match the tested condition of the rule, the resource monitor 302 adds the resource and value associated with the parameter and the value of the parameter to a trigger cause list associated with the rule (step 824). The resource monitor 302 changes a flag or other indicator associated with the rule to indicate that the resource monitor 302 has changed values of variables associated with the rule (step 826). After determining whether the current condition of the parameter matched a tested condition of the rule, and examining each rule (step 828), the resource monitor 302 evaluates the policy (step 830).

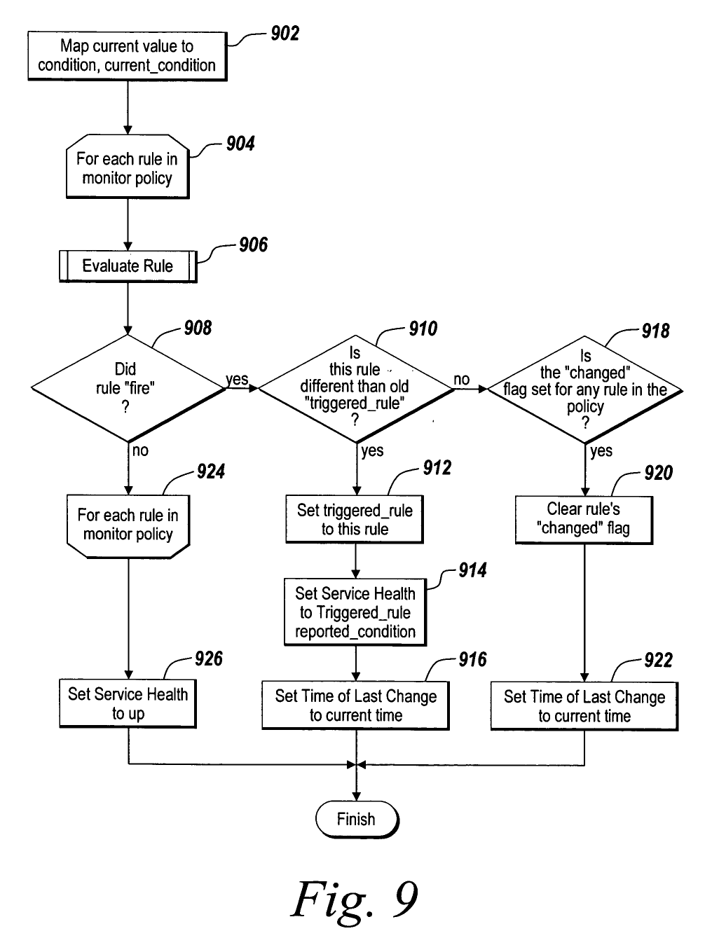

Referring now to FIG. 9, a flow diagram depicts one embodiment of the steps taken to evaluate a policy. The resource monitor 302 maps the current value of a parameter to a condition and stores the result in a variable that stores the current condition (step 902). For each rule in the monitor policy (step 904), the resource monitor 302 completes an evaluation process (step 906).

The resource monitor 302 examines whether the rule fired (step 908). In one embodiment, a rule fires if the evaluation of the rule returns a value of true. In some embodiments, rules are ordered. In these embodiments, multiple rules may return true values when evaluated but only the first value of true (in order of precedence) sets the value of the service health. In these embodiments, the first rule in the ordered rules to fire may be referred to as a triggered rule. In some embodiments, the rule contexts are stored for all rules that fire, and not just the rule context for the triggered rule. In these embodiments, a triggered rule for a service or resource monitor may evaluate to false after an exemption, in which case the other rules that fired may be re-evaluated to determine whether downtime or degraded time should still be accumulated, in spite of the change in the triggered rule.

If the resource monitor 302 determined that the rule did fire, the resource monitor 302 determines whether the rule is different from the value of a variable representing a triggered rule (step 910). If so, the resource monitor 302 sets a condition data structure containing a variable to identify the rule being examined (step 912) and a variable to identify the current service health (step 914). The resource monitor 302 uses the current time to set a variable representing the time of the last change to the examined rule (step 916).

If the resource monitor 302 determines that the rule did fire but is not different from the value of a variable representing a triggered rule, the resource monitor 302 determines whether a flag identifying a change is set for any rule in the policy (step 918). If so, the resource monitor 302 resets the value of a flag or other indicator so that it no longer indicates a change (step 920). The resource monitor 302 then uses the current time to set a variable representing the time of the last change to the examined rule (step 922).

If the resource monitor 302 determines that none of the rules in the rule set fired, the service health is considered acceptable (step 926).

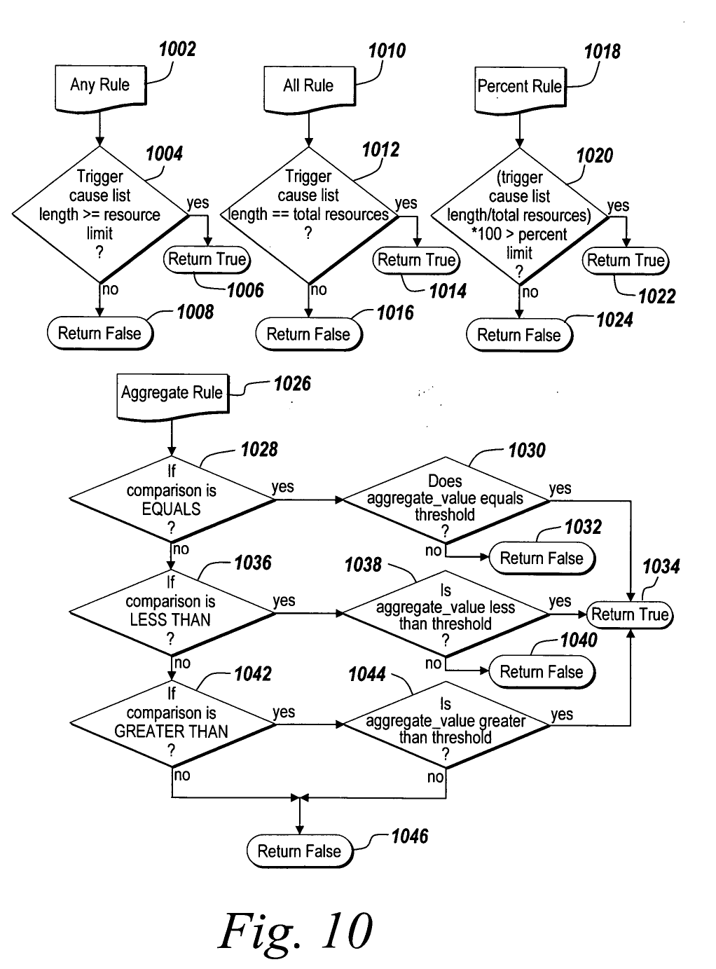

Referring now to FIG. 10, flow diagrams depict one embodiment of the steps taken to evaluate a rule. In some embodiments, a rule 1002 indicates that an action should be taken when a resource limit has been reached. In these embodiments, a resource limit indicates a limit to the number of resources providing unacceptable service. A resource monitor 302 adds resources to a list of triggered causes during the process of responding to a parameter value change described above for FIG. 8. As depicted in FIG. 10, when a resource monitor 302 evaluates a rule, the resource monitor 302 identifies the length of the list of triggered cause list. The resource monitor 302 determines whether the list length is greater than or equal to the resource limit (step 1004). If so, the resource monitor 302 returns a value of true, indicating that the rule has been satisfied (step 1006). If not, the resource monitor 302 returns a value of false, indicating that the rule has not been satisfied (step 1008). A rule that has been satisfied may be considered a rule that fired. As a result of determining that the rule has fired, the rule may become a triggered rule, depending upon its order in an ordered set of rules, and a change results in the variable indicating a reported condition. In some embodiments, a change in the variable indicating a reported condition may result in an action being taken to indicate the change.

In other embodiments, a rule 1010 indicates than an action should be taken when all resources are providing unacceptable service. In these embodiments, a count of total resources represents the number of resources. A resource monitor 302 adds resources to a list of triggered causes during the process of responding to a parameter value change described above for FIG. 8. As depicted in FIG. 10, when a resource monitor 302 evaluates a rule, the resource monitor 302 identifies the length of the list of triggered cause list and determines whether the list length is equal to the number of total resources (step 1012). If so, the resource monitor 302 returns a value of true, indicating that the rule has been satisfied (step 1014). If not, the resource monitor 302 returns a value of false, indicating that the rule has not been satisfied (step 1016).

In still other embodiments, a rule 1018 indicates than an action should be taken when a particular percentage of resources are providing unacceptable service. A percentage of the total amount of available resources is identified. A resource monitor 302 adds resources to a list of triggered causes during the process of responding to a parameter value change described above for FIG. 8. As depicted in FIG. 10, when a resource monitor 302 evaluates a rule, the resource monitor 302 identifies the length of the list of triggered cause list and determines whether the list length is greater than the particular percentage identified. If so, the resource monitor 302 returns a value of true, indicating that the rule has been satisfied (step 1022). If not, the resource monitor 302 returns a value of false, indicating that the rule has not been satisfied (step 1024).

In yet other embodiments, a rule 1026 indicates that an action should be taken responsive to a particular threshold. The resource monitor 302 compares an identified threshold with the value of aggregating resources affected by parameter changes to determine whether the values are equal (step 1028). If the resource monitor 302 determines that the aggregate value equals the threshold value (step 1030), the rule has been satisfied and the resource monitor 302 returns true (step 1034). Otherwise, the rule has not been satisfied and the resource monitor 302 returns false (step 1032).

Another comparison the resource monitor 302 may make is a less than comparison (step 1036). If the resource monitor 302 determines that the aggregate value is less than the threshold value (step 1038), the rule has been satisfied and the monitor resource 302 returns true (step 1034). Otherwise, the rule has not been satisfied and the resource monitor 302 returns false (step 1040).

A resource monitor 302 may make a comparison to determine whether one value is greater than the other (step 1042). If the resource monitor 302 determines that the aggregate value is greater than the threshold value (step 1044), the rule has been satisfied and the resource monitor 302 returns true (step 1034). Otherwise, the rule has not been satisfied and the resource monitor 302 returns false (step 1046). Similarly if no comparison can be made or the comparison to be made is not one of equal to, greater than or less than, the resource monitor 302 returns false (step 1046). For a resource monitor 302 to return false due to the comparison to be made not requiring a comparison of equal to, greater than, or less than, indicates, in some embodiments, a data integrity flaw Referring now to FIG. 11, a flow diagram depicts in greater detail one embodiment of the steps taken to add or remove a resource from consideration in determining the resources to include in identifying aggregate values. In the course of monitoring a business process, in some embodiments, resources will be added and removed from the model of the business process. For non-aggregate rules, a re-evaluation of the rule occurs when another resource is added or removed. The aggregate rule used in one embodiment of the present invention further comprises logic to increase the efficiency of the re-evaluation process. The aggregate rule in this embodiment further comprises an algorithm to determine whether a full evaluation of the rule is necessary after the addition or removal of a resource. FIG. 11 depicts one embodiment of this algorithm. In brief overview, if the changed flag is set to true, some re-evaluation of the rule occurs, and that re-evaluation may result in a change to a variable indicating a condition associated with a resource monitor.

Referring now to FIG. 11, and in greater detail, if a resource monitor 302 determines to remove a value from the existing aggregate value (step 1102), the resource monitor 302 decrements the value count (step 1104). The removal of the value from the existing aggregate value may represent the removal of a resource. If the decrementing of the value results in a new value equal to an amount represented by a variable, labeled “SUM,” (step 1106) the resource monitor 302 sets a variable to indicate that a change has occurred (step 1108) and subtracts the value from the aggregate (step 1110). If the decrementing of the value results in a new value equal to an amount falling within a range of values and if the resource removed was associated with the triggered list (step 1112), the resource monitor 302 removes the value from the list of triggered variables (step 1114), sets a variable to indicate that a change has occurred (step 1116), and re-evaluates the remaining values (step 1118). If the decrementing of the value results in a new value equal to an average (step 1120), the resource monitor 302 sets a variable to indicate that a change has occurred (step 1122), subtracts the value from the current sum (step 1124), and determines to update the value in a variable representing the aggregate value of the remaining resources (step 1126).

If a resource monitor 302 determines to add a value to the existing aggregate value (step 1130), the resource monitor 302 increases the value (step 1132). The removal of the value from the existing aggregate value may represent the removal of a resource. If the incrementing of the value results in a new value equal to an amount represented by a variable, labeled “SUM,” (step 1134) the resource monitor 302 sets a variable to indicate that a change has occurred (step 1136) and adds the value to the aggregate (step 1138).

If the incrementing of the value results in a new value equal to an amount falling within a range of values and if adding the resource would violate a comparison to this threshold (step 1140), the resource monitor 302 adds the resource to the list representing triggered items (step 1142), sets a variable to indicate that a change has occurred (step 1144) and determines whether the new value trumps the current aggregate (step 1146). If so, then the resource monitor 302 sets the current aggregate to the new variable (step 1148). If the incrementing of the value results in a new value equal to an average (step 1150), the resource monitor 302 sets a variable to indicate that a change has occurred (step 1152), adds the value to the current sum (step 1154) and updates the value in a variable representing the aggregate value of the resources (step 1156).

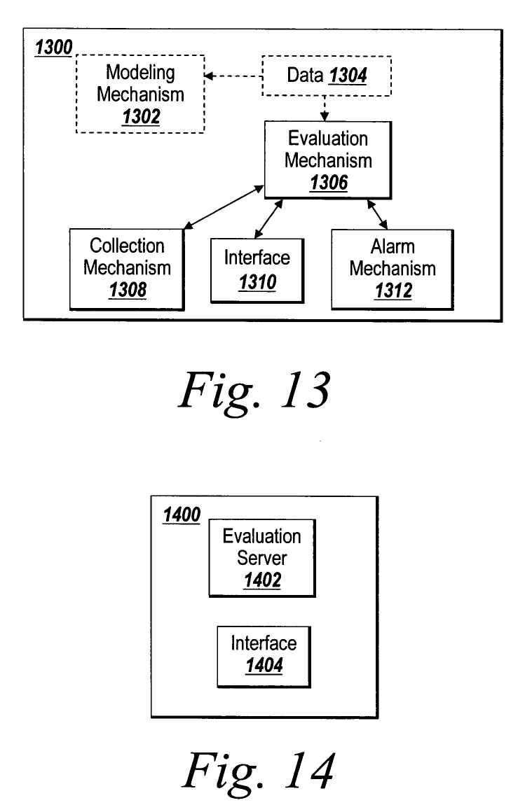

Referring now to FIG. 13, a block diagram depicts an embodiment of a system for monitoring a business process associated with a network, including an evaluation mechanism 1306, a collection mechanism 1308, an interface 1310, and an alarm mechanism 1312. In brief overview, the evaluation mechanism 1306 is configured to determine an operational characteristic of a business process. The collection mechanism 1308 is configured to gather information about a change in the operational characteristic of the business process. The interface 1310 is configured to collect information about a state of an event associated with a change in the operational characteristic of the business process. The alarm mechanism 1312 is configured to take an action when a change in the operational characteristic of the business process occurs.

Referring now to FIG. 13, and in more detail, in one embodiment the evaluation mechanism 1306 is configured to determine an operational characteristic of the business process. In one embodiment, the evaluation mechanism 1306 comprises an SLA evaluator 206. In some embodiments, the evaluation mechanism 1306 determines an operational characteristic of the business process by evaluating data received about the business process. In other embodiments, the evaluation mechanism 1306 determines an operational characteristic of the business process by evaluating a state of an event associated with an operational characteristic of a business process.

The collection mechanism 1308 is configured to gather information about a change in the operational characteristic of the business process. In one embodiment, the collection mechanism 1308 comprises an SLA model 204. In another embodiment, the collection mechanism 1308 comprises a service infrastructure model 208. In some embodiments, the collection mechanism 1308 comprises the functionality of both the SLA model 204 and the service infrastructure model 208.

The interface 1310 is configured to collect information about a state of an event associated with a change in the operational characteristic of the business process. In one embodiment, the interface comprises a reporting and exemption interface 210. In another embodiment, the interface 1310 comprises a service infrastructure model 208.

The alarm mechanism 1312 is configured to take an action when a change in the operational characteristic of the business process occurs. The alarm mechanism 1312 may comprise a guarantee 306. The alarm mechanism 1312 may comprise a resource monitor 302.

There may be a model of a business process. In one embodiment, the evaluation mechanism 1306 determines an operational characteristic of the business process by evaluating data received from a model of the business process. In some embodiments, the evaluation mechanism 1306 receives data from a proxy server. In other embodiments, the evaluation mechanism 1306 receives data from the interface 1310. In embodiments where the evaluation mechanism 1306 receives data, it may determine the operational characteristic of the business process by evaluating the received data.

In some embodiments, the evaluation mechanism 1306 receives data 1304 from the modeling mechanism 1302, shown in shadow in FIG. 13. In these embodiments, the modeling mechanism 1302 comprises a mechanism for collecting data 1304, shown in shadow in FIG. 13, about at least one state of an event associated with the change in the operational characteristic of the business process. In some embodiments, the modeling mechanism 1302 receives data 1304 about the business process from a network management system. In other embodiments, the modeling mechanism 1302 collects the data 1304 about the business process directly from the business process.

In some embodiments, the evaluation mechanism 1306 determines a cause for the change in the operational characteristic of the business process by evaluating a state of an event. In these embodiments, the state of the event is associated with at least one element of a business process. In some embodiments, a parameter comprises a state of an event.

In some embodiments, the evaluation mechanism 1306 receives data 1304 about a state of the event from the interface 1310. In some of these embodiments, the evaluation mechanism 1306 takes an action to modify the state of the event in determining the cause for the change in the operational characteristic of the business process based upon evaluating received data.

Referring now to FIG. 14, a block diagram depicts an embodiment of a system for determining an operational characteristic of a business process associated with a network, including an evaluation server 1402 and an interface 1404. In brief overview, the interface 1404 transmits system information collected from one or more resources to the evaluation server 1402, which determines an operational characteristic of the business process.

Referring now to FIG. 14, and in more detail, the interface 1404 collects system information from one or more resources. In one embodiment, the interface is a reporting and exemption interface 210. In another embodiment, the interface is an SLA model 204.

In some embodiments, the resources about which the interface 404 collects system information are business process elements. In other embodiments, the resources are states of an event associated with a business process. In some of these embodiments, the states of an event monitor the business process. In others of these embodiments, the states of an event indicate whether a business process is subject to or exempt from a service level agreement.

In one embodiment, the interface 1404 collects system information indicating that the state of the event indicates an exemption of the event from a service level agreement. In another embodiment, the interface 1404 collects system information indicating that the state of the event indicates that an event is subject to a service level agreement.

In some embodiments, the system further comprises a modeling mechanism. In one of these embodiments, the modeling mechanism models the business process associated with the network. In another of these embodiments, the modeling mechanism collects information about the business process. In yet another embodiment, the modeling mechanism transmits information about the business process to the evaluation server 1402.

The evaluation server 1402 monitors a state of a business process and identifies an operational characteristic of a business process based upon a state of an event associated with the business process. In some embodiments, the evaluation server 1402 comprises an SLA evaluator 206. The evaluation server 1402 receives system information from the interface 1404 and makes a determination as to the operational characteristic of the business process based upon the received system information.

In one embodiment, the evaluation server 1402 modifies a determination as to an operational characteristic of the business process. In some embodiments, the evaluation server 1402 changes the operational characteristic of the business process. In one of these embodiments, the evaluation server 1402 makes the change responsive to system information received from the interface 1404.

In some embodiments, the evaluation server 1402 receives system information that indicates a change to a state of an event associated with the operational characteristic of the business process. In some of these embodiments, the evaluation server 1402 makes a change to the operational characteristic responsive to the state of the event.

In some embodiments, the operational characteristic of the business process indicates a level of downtime. In other embodiments, the operational characteristic of the business process indicates a level of degradation of a business process service. In still other embodiments, the operational characteristic of the business process indicates a level of loss of redundancy.

In one embodiment, the evaluation server 1402 changes an operational characteristic from indicating a level of unacceptable service to indicating a level of acceptable service. In this embodiment, an event may occur to change the level of service and the state of the event may indicate that the event is exempt from a service level agreement. In another embodiment, an event may occur to change the level of service by providing improved service.

In another embodiment, the evaluation server 1402 changes an operational characteristic from indicating a level of acceptable service to indicating a level of unacceptable service. In this embodiment, an event may occur to change the level of service and the state of the event may indicate that the event is subject to a service level agreement.

The present invention may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more articles of manufacture as object code.

While the invention has been shown and described with reference to specific preferred embodiments, it should be understood by those skilled in the art that various changes in form and detail may be made therein without departing from the spirit and scope of the invention as defined by the following claims.

What is claimed is:

1. A method for monitoring a business process associated with a network, the method comprising the steps of:
determining an operational characteristic of a business process;
taking an action to modify a state of an event associated with a change in the operational characteristic of the business process; and
re-determining the operational characteristic of the business process.

2. The method of claim 1 further comprising the step of, monitoring a state of an event associated with a business process element.

3. The method of claim 1, wherein the step of taking an action to modify a state of an event associated with a change in the operational characteristic of the business process further comprises marking the state of the event as exempt from a service level agreement.

4. The method of claim 1, wherein the step of taking an action to modify a state of an event associated with a change in the operational characteristic of the business process further comprises marking the state of the event as subject to a service level agreement.

5. The method of claim 1 further comprising the step of, determining a cause for the change in the operational characteristic of the business process.

6. The method of claim 5 further comprising the step of determining a state of an event associated with the cause for the change in the operational characteristic of the business process.

7. The method of claim 5 further comprising the step of collecting data associated with the cause for the change in the operational characteristic of the business process.

8. The method of claim 7 further comprising the step of storing the data associated with the cause for the change in the operational characteristic of the business process.

9. The method of claim 1, wherein the step of determining a change in an operational characteristic of the business process further comprises the step of evaluating the state of the event.

10. The method of claim 1, wherein the operational characteristic indicates an availability of a business process service.

11. The method of claim 1, wherein the step of re-determining the operational characteristic of the business process further comprises taking an action to disregard an event.

12. The method of claim 1, wherein the step of re-determining the operational characteristic of the business process further comprises applying a rule to the operational characteristic to determine whether to transmit an alert.

13. The method of claim 1, wherein the step of re-determining the operational characteristic of the business process occurs automatically.

14. The method of claim 1, further comprising the step of modeling the business process.

15. In a computational hardware device, a method for analyzing an operational characteristic of a business process associated with a network, the method comprising the steps of:
receiving data about a business process;
analyzing an operational characteristic of the business process;
receiving an input to modify a state of an event associated with the operational characteristic;
modifying the state of the event; and
re-analyzing the operational characteristic of the business process responsive to the modified state of the event.

16. The method of claim 15, further comprising storing data relating to the modification of the state of the event associated with the operational characteristic of the monitored business process.

17. The method of claim 15, further comprising the step of modeling the business process.

18. The method of claim 15, wherein the step of re-analyzing the operational characteristic of the business process occurs automatically.

19. The method of claim 15, wherein the step of modifying the state of the event further comprises marking the state of the event as exempt from a service level agreement.

20. The method of claim 15, wherein the step of modifying the state of the event further comprises marking the state of the event as subject to a service level agreement.

21. The method of claim 15, further comprising the step of determining to send an alarm when a change in the operational characteristic of the monitored business process occurs.

22. The method of claim 21, wherein the step of determining to send an alarm further comprises applying a rule to determine to send the alarm.

23. The method of claim 22, wherein the rule requires sending an alert when all states of the event have a pre-defined state.

24. The method of claim 22, wherein the rule requires sending an alert when a percentage of the states of the event have a pre-defined state.

25. The method of claim 22, wherein the rule requires sending an alert when the aggregate of the states of the event have a pre-defined state.

26. A system for monitoring a business process associated with a network comprising:
an evaluation mechanism configured to determine an operational characteristic of the business process;
an interface configured to collect information about a state of an event associated with a change in the operational characteristic of the business process;
a collection mechanism configured to gather information about the change in the operational characteristic of the business process; and
an alarm mechanism configured to take an action when a change in the operational characteristic of the business process occurs.

27. The system of claim 26, wherein the evaluation mechanism further comprises determining a change in the operational characteristic of the business process by evaluating data received about the state of the event.

28. The system of claim 27, wherein the evaluation mechanism further comprises taking an action to modify the state of the event in determining the cause for the change in the operational characteristic of the business process based upon evaluating the received data.

29. The system of claim 26, wherein the evaluation mechanism receives data about the state of the event from the interface.

30. The system of claim 26, wherein the evaluation mechanism receives data about the state of the event from a proxy server.

31. The system of claim 26, further comprising a modeling mechanism collecting data about at least one state of an event associated with the change in the operational characteristic of the business process.

32. The system of claim 31, wherein the modeling mechanism receives data about the business process from a network management system.

33. The system of claim 31, wherein the evaluation mechanism receives data from the modeling mechanism.

34. The system of claim 26, wherein the evaluation mechanism further comprises automatically re-evaluating the operational characteristic of the business process.

35. The system of claim 26, wherein the interface further comprises collecting information indicating that the state of the event is exempt from a service level agreement.

36. The system of claim 26, wherein the interface further comprises collecting information indicating that the state of the event is subject to a service level agreement.

37. A system for determining an operational characteristic of a business process associated with a network comprising:
an interface to collect system information from one or more resources; and
an evaluation server monitoring a state of a business process associated with a network, identifying an operational characteristic of the business process based upon a state of an event associated with the business process, receiving system information from the interface, and making a determination as to the operational characteristic of the business process based upon the received system information.

38. The system of claim 37, wherein the interface further comprises collecting system information indicating that the state of the event indicates an exemption from a service level agreement.

39. The system of claim 37, wherein the interface further comprises collecting system information indicating that the state of the event is subject to a service level agreement.

40. The system of claim 37, further comprising a modeling mechanism modeling the business process associated with the network.

41. The system of claim 37, wherein the evaluation server further comprises modifying the determination as to the operational characteristic of the business process.

42. The system of claim 37, wherein the evaluation server further comprises making the determination as to the operational characteristic of the business process automatically.

43. The system of claim 37, wherein the operational characteristic of the business process indicates a level of downtime.

44. The system of claim 37, wherein the operational characteristic of the business process indicates a level of degradation of a network service.

45. The system of claim 37, wherein the operational characteristic of the business process indicates a level of loss of redundancy.

46. A computer readable medium holding computer readable instructions for performing a method for monitoring a business process associated with a network, the method comprising the steps of:
determining an operational characteristic of a business process;
modifying a state of an event associated with a change in the operational characteristic of the business process; and
automatically re-determining the operational characteristic of the business process.

47. The medium of claim 46 further comprising the step of, monitoring a state of an event associated with a business process element.

48. The medium of claim 46, wherein the step of modifying a state of an event associated with a change in the operational characteristic of the business process further comprises the step of identifying the state of the event as exempt from a service level agreement.

49. The medium of claim 46, wherein the step of modifying a state of an event associated with a change in the operational characteristic of the business process further comprises the step of identifying the state of the event as subject to a service level agreement.

50. The medium of claim 46 further comprising the step of, determining a cause for the change in the operational characteristic of the business process.

51. The medium of claim 50 further comprising the step of determining a state of an event associated with the cause for the change in the operational characteristic of the business process.

52. The medium of claim 50 further comprising the step of collecting data associated with the cause for the change in the operational characteristic of the business process.

53. The medium of claim 52 further comprising the step of storing the data associated with the cause for the change in the operational characteristic of the business process.

54. The medium of claim 46, wherein the step of determining a change in an operational characteristic of the business process further comprises the step of evaluating the state of the event.

55. The medium of claim 46, wherein the operational characteristic indicates an availability of a business process service.

56. The medium of claim 46, wherein the step of automatically re-determining the operational characteristic of the business process further comprises the step of taking an action to disregard an event.

57. The medium of claim 46, wherein the step of automatically re-determining the operational characteristic of the business process further comprises the step of applying a rule to the operational characteristic to determine whether to transmit an alert.

58. The medium of claim 46, further comprising the step of modeling the business process.
